(19) United States
(12) Patent Application Publication
(10) Pub. No.: US 2013/0166309 A1
(43) Pub. Date: Jun. 27, 2013

(54) BUSINESS PROCESS ADAPTATION TECHIQUES

(71) Applicants: Johann KEMMER, Muehlhausen (DE); Martina ROTHLEY, Schwetzingen (DE); Thomas WALTER, Muehlhausen (DE)

(72) Inventors: Johann KEMMER, Muehlhausen (DE); Martina ROTHLEY, Schwetzingen (DE); Thomas WALTER, Muehlhausen (DE)

(21) Appl. No.: 13/334,623

(22) Filed: Dec. 22, 2011

(51) Int. Cl. G06Q 10/00

(52) U.S. Cl. 705/1.1

(57) ABSTRACT

Enhancement and adaptation of standard predefined business processes within a business software solution is performed by reusing business process elements, which are granular parts of the business processes. Connection of business entities to the reused business process elements ensures consistent business process adaptation. New business processes are defined in addition to the predefined business processes.

### FIELD

The field relates to business software applications. More precisely, the field relates to adaptation of pre-delivered business processes in standard business software applications.

### BACKGROUND

Software partners often need to modify business processes provided for in standard business software applications. The modification should be applied consistently across the whole technology stack, including all involved business entities such as user interfaces, forms, reports, tasks, etc. in an easy to use manner. Such adaptations to standard business processes include shortening and extension of standard processes; replacement of parts of the standard business process by other standard process elements; and replacement of complete standard process by self-defined business processes consisting of standard business process elements. As a result, the self-defined business processes are tailored exactly to customer or industry-specific needs.

Flexible definition of business processes is challenging or simply not possible for customers and software implementation partners relying on standard business application products. The standard business processes offered by those products are in general inflexible and rigid and do not provide any ability to modify or enhance business process chains.

Even in the rare cases, where business process definition in a standard product is allowed, such functionality is either restricted to very special use cases such as process-oriented field extensibility or the functionality is not able to provide the relation between business process elements and business entities.

Furthermore, there are no means for users to adapt standard business processes that gives them access to all the required capabilities like standard business process elements, but at the same time hides the complexity by implementing automation to transport the adaptation to all related business entities. The automation in transporting the adaptation to all related business entities is to ensure consistent behavior of the whole software solution.

As a consequence, customers have to adapt their real-time business to the software standards often leading to additional, unnecessary costs and lowering efficiency and productivity. On the other hand, software partners are forced to implement the required processes from scratch on their own in separate, stand-alone software products instead of adapting standard ERP software and making use of its rich portfolio of predefined business processes.

### SUMMARY

Various embodiments of systems and methods for business process adaptation are described herein. In one embodiment, the method includes identifying pre-delivered business process elements for business process composition and reusing the identified pre-delivered business process elements to compose a developed business process. The method also includes switching entities to the developed business process based on the reused identified pre-delivered business process elements and persisting the developed business process in a repository.

In other embodiments, the system includes a processor for executing program code and memory in communication with the processor. The system also includes an identifier module to identify pre-delivered business process elements for business process composition and a composer module to reuse the identified pre-delivered business process elements to compose a developed business process. The system further includes a connector module to switch business entities to the developed business process based on the reused identified pre-delivered business process elements and a repository module to persist the developed business process.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing a system of business process adaptation, according to one embodiment.

FIG. 2 is a flow diagram of an embodiment of a method of business process adaptation.

FIG. 3 is a block diagram of an embodiment of a system of business process adaptation.

FIG. 4 is an exemplary screenshot depicting a user tool designed for customers or partner development workbench supporting the process of partner add-on development.

FIG. 5 is an exemplary screenshot depicting a tool for business process adaptation, according to an embodiment.

FIG. 6 is a block diagram illustrating a computing environment in which the techniques described for business process adaptation can be implemented, according to an embodiment.

### DETAILED DESCRIPTION

Embodiments of techniques for business process adaptation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

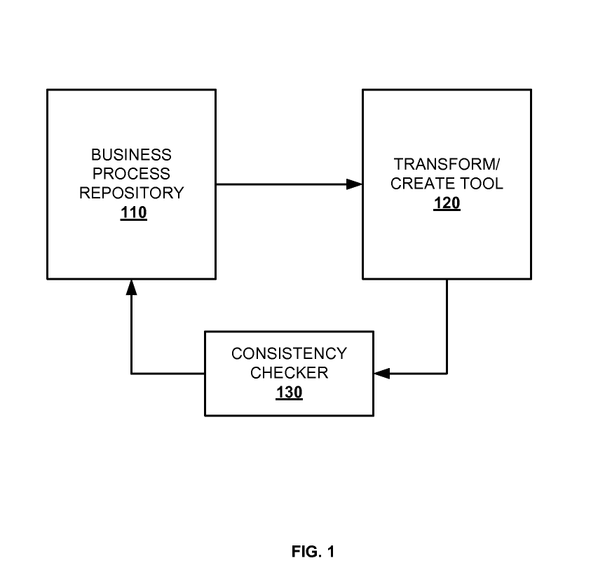

FIG. 1 is a block diagram representing a system of business process adaptation, according to one embodiment. A business process repository 110 includes standard business processes and business process elements. Standard business processes are business processes that are predefined and stored in the business process repository 110. Business process elements are the most granular pieces of a business process in terms of business process composition. Business processes include one or more business process elements. Standard business processes and standard business process elements may be defined in a metadata repository such as the business process repository 110.

Business objects are real world objects. For example, an employee or a sales order may be modeled as business objects in business application systems. Business objects are composed of business object nodes representing individual aspects of the business object. In one embodiment, business process elements are composed by two business object nodes. Two business object nodes representing a business process element may also represent the data flow between them. The data flow starts with the source (typically left side) of the business process element and ends at the target (typically right side) of the business process element. This holds true in case both business objects belong to the same deployment unit. Otherwise, business process elements consist of two business object nodes and their process agents. Process agents are pieces of software connecting two business objects, which rely on different deployment units, which themselves could be deployed on different systems or tenants. In case a business process element crosses deployment unit boundaries, a direct communication between business objects is not suitable as each deployment unit may reside in a different system requiring a message-based communication. Therefore, the partner business process definition also contains the information about involved process agents, which represent the outbound and inbound application-to-application (A2A) messages. Examples of business process elements are:

Sales Quote Item->Sales Order Item; and

Sales Order Header->Service Confirmation Header.

As stated above, the left side of the business process elements is typically the source and the right side is typically the target, which also depicts the data flow between the nodes building a business process element.

In one embodiment, the transform/create tool 120 is operable to adapt existing business processes or create new business processes according to the business needs. The transform/create tool 120 is designed to easily adapt and enhance predefined business processes provided by a standard business software application. The transform/create tool 120 is operable to define completely new business processes in addition to the predefined business processes or as a substitute for standard business processes by reusing predefined business process elements. The transform/create tool 120 is provided with reusable business process elements by the business process repository 110. After transforming an existing business process or creating a new business process by the transform/create tool 120, a consistency checker 130 is responsible to connect or disconnect business entities to the reused business process elements to guarantee consistent business process adaptation. Examples of business entities relevant to business processes for a standard business software application are: business objects and business object nodes; user interfaces, such as work centers; work center views, floor plans to create, update, delete and display of business objects, queries, etc.; print forms, interactive forms; analytical reports; and tasks. To connect or disconnect the business entities to the respective business process elements, the consistency checker 130 should be aware of the relation between the business entities and the business process elements. In some embodiments, the mechanism to connect or disconnect business entities to business process elements may also be referred to as Business Entity Process Switches. Business entities are assigned to one edge (source or target) of a business element, thus a business object node. The system automatically resolves the relationship between the business entity, the business object node as part of a business process element and the business process element itself.

Business entities of a business software solution are assigned to one or more business process elements. Standard software delivery includes the assignment of all relevant business entities to business process elements. Multiple assignments of one business entity to several business process elements may be possible, because most standard business entities participate in more than one business process. Examples of assignment of business entities to standard business process elements are:
Business Entity: Work Center View “Sales Order” [symbol] Business Process Element “Sales Order to Service Order”, BO node “Sales Order Header”;
Business Entity: Report “Invoicing Volume” [symbol] Business Process Element “Customer Invoicing to Supplier Invoicing”, BO node “Customer Invoicing Header”; and
Business Entity: Form “Service Order Confirmation” [symbol] Business Process Element “Service Order to Service Order Confirmation”, BO node “Service Confirmation Header”.

The assignment of standard business entities to further business process elements by a customer or software implementation partner should be possible to ensure consistency of the adapted business processes. Standard business software solution delivery contains switches for standard business entities and standard business process elements. The business configuration decides the activation status of each switch. If business processes are de-selected in scoping, the corresponding business entity switches are switched off. After the activation of a business process adaptation or definition (see Table 1) the corresponding process switches are evaluated and will be activated or de-activated.

TABLE 1

| | Business Process | | Process |
|---|---|---|---|
| Business Entity | Element | BO Node | Switch |
| Work Center View | Quote to | Service Order | off |
| ,,Service Orders“ | Service Order | Header | |
| Work Center View | Service Order | Service Order | on |
| ,,Service Orders“ | to Service | Header | |
| | Confirmation | | |
| Report | Opportunity to | Sales Order | off |
| ,,Sales Volume“ | Sales Order | Header | |
| Report | Service Order to | Service Order | off |
| ,,Sales Volume“ | Invoice Request | Header | |

As a consequence, business entities will be switched on or off depending on their active process switches. During runtime, a business entity is switched off only if all its business process switches are off; on the other hand, a business entity is switched on, if at least one of its business process switches is on. In the example given in Table 1, the report “Sales Volume” should be switched off completely in runtime.

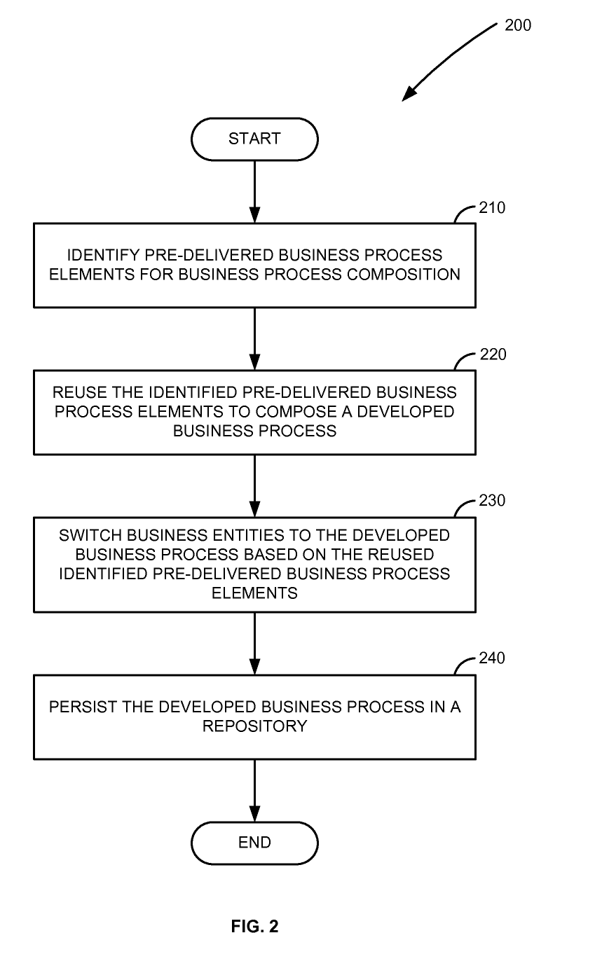

FIG. 2 is a flow diagram of an embodiment of a method 200 of business process adaptation. The method begins at block 210 with identifying pre-delivered business process elements for business process composition. In one embodiment, the business process elements are granular pieces for the business process composition. In one embodiment, the business process elements are composed by two business object nodes representing also the data flow between the two business objects.

Further, at block 220, the identified pre-delivered business process elements are reused to compose a developed business process. In one embodiment, reusing the business process elements includes adapting a predefined business process based on the identified pre-delivered business process elements. In another embodiment, adapting a predefined business process includes adding identified pre-delivered business process elements to the predefined business process and removing identified pre-delivered business process elements from the predefined business process.

Then, at block 230, switching business entities to the developed business process based on the reused identified pre-delivered business process elements is performed. This step ensures consistency for the newly developed business process. In one embodiment, the relationship between the reused identified pre-delivered business process elements and the business entities are determined. In some embodiments, business entities relevant to business processes for a standard business software application may be: business objects and business object nodes; user interfaces, such as work centers, work center views, floorplans for create, update, delete and display of business objects, queries, etc.; print forms, interactive forms; analytical reports; and tasks.

At block 240, the developed business process is persisted in a repository. The repository includes business processes and business process elements that may be reused for further business process adaptation.

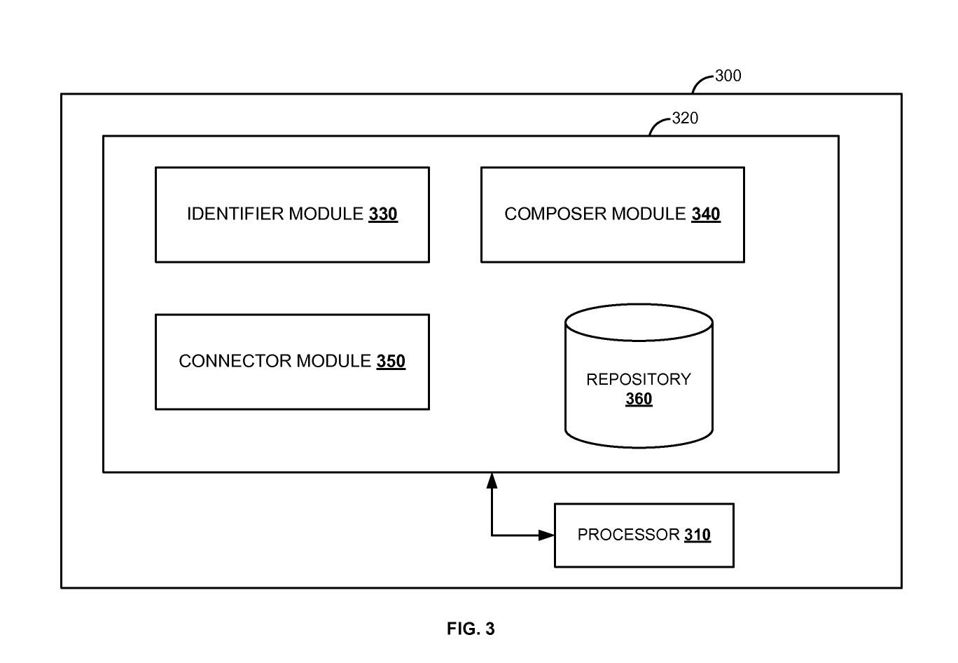

FIG. 3 is a block diagram of an embodiment of a system 300 of business process adaptation. The system 300 includes a processor 310 for executing program code and computer memory 320 in communication with the processor 310. The system 300 further includes an identifier module 330 to identify pre-delivered business process elements for business process composition. In one embodiment, the business process elements are granular pieces for the business process composition. In one embodiment, the business process elements are composed by two business object nodes representing also the data flow between the two business objects.

A composer module 340 is operable to reuse the identified pre-delivered business process elements by the determinator module 330 to compose a developed business process. In one embodiment, the composer module 340 is further operable to adapt a predefined business process through the identified pre-delivered business process elements. In another embodiment, the composer module 340 is further operable to add identified pre-delivered business process elements to the predefined business process and remove identified pre-delivered business process elements from the predefined business process.

A connector module 350 is operable to switch business entities to the developed business process based on the reused identified pre-delivered business process elements. This module ensures consistency for the newly developed business process. In one embodiment, the connector module 350 is operable to determine the relationship between the reused identified pre-delivered business process elements and the business entities.

A repository module 360 is intended to persist the developed business process. The repository module 360 is used to persist business processes and business process elements that may be reused for further business process adaptation.

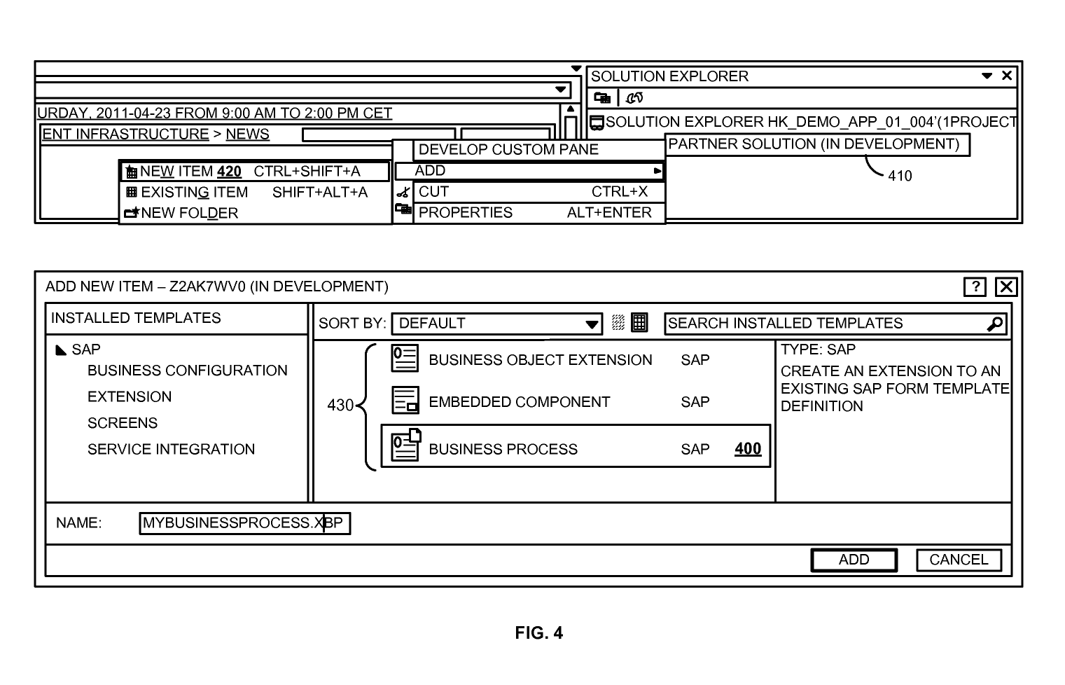

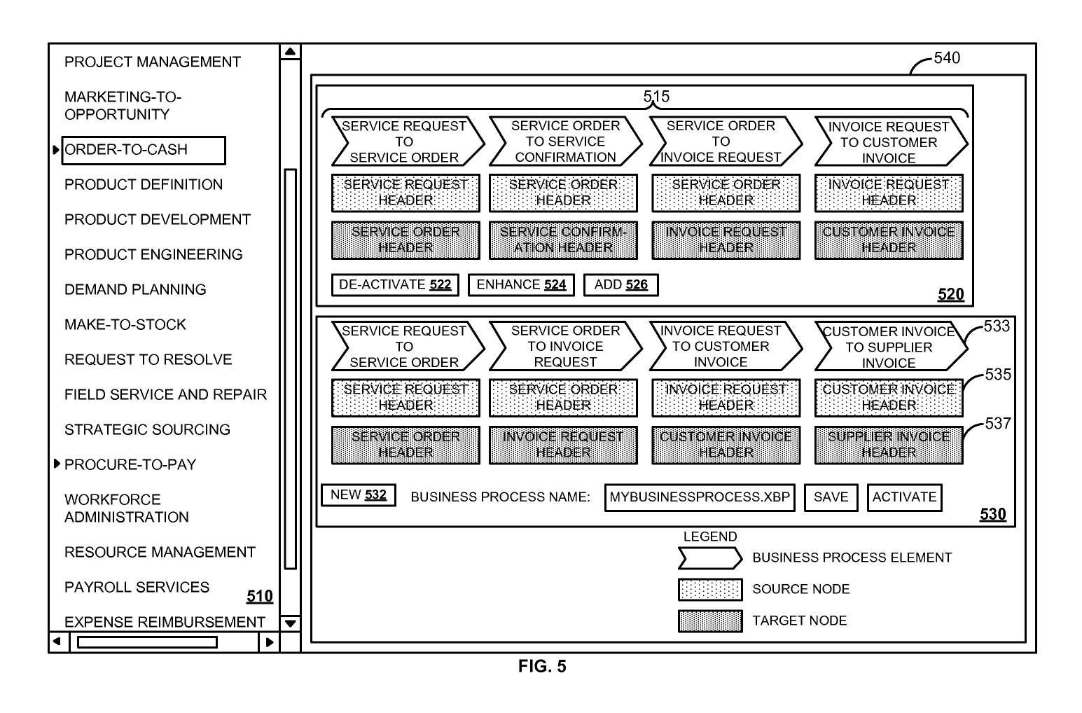

A tool for the adaptation of standard business processes and the composition of new business processes may be embedded into a key user tool designed for customers or a partner development workbench supporting the whole process of partner add-on development. As an example, the business process adaptation and composition for software implementation partners is depicted in FIG. 4 and FIG. 5. A tool for customer process definition could be realized in a similar way.

Partners using a development workbench could start a business process adaptation and composition by selecting a predefined template as depicted in FIG. 4. The business process template may be chosen by adding a new item 420 to an add-on solution 410 created by an implementation partner and then choosing the business process template 400 from a list of possible development entities 430. After the selection of the template for the business process adaptation, a tool for the selection of standard business processes and the editing of the business processes will be opened. An exemplary tool for the selection of standard business processes and the editing of the business processes is depicted in FIG. 5. The business process selection area 510 is used to specify a concrete standard business process to be adapted or to be used as a template for a new business process. A business process editor 540 depicts the business process according to the selection made in the business process selection area 510. The process elements are shown as Chevron graphs 515. The business process editor 540 includes a business process adaptation area 520 and business process composition area 530. The tool serves two purposes: adaptation of standard business processes and composition of new business processes. The new business processes may be individually delivered into a customer system or added as a business software application add-on. The business process adaptation area 520 is where the selected standard business process is displayed in its process elements, including the functions for deactivation 522 and enhancement 524. The business process composition area 530 is where the business processes may be composed process element by process element or enhanced by further business process elements picked up from a business process selected to the business process adaptation area 520. In the tool, the business process elements are displayed by their names (e.g. 533). Additionally, the source and the target business object nodes are given (e.g. 535 and 537 respectively). The tool may also be re-used as a business process editor in order to allow changes to the adapted or newly defined business processes later on.

For business process adaptation, the user selects one of the pre-delivered standard business processes from the left side of the tool (e.g. Processing Purchase Orders). Automatically, the business process elements that the standard business process is composed of are displayed in the business process editor window 540on the right side of the tool, e.g. as Chevron graphs (e.g. Processing Purchase Orders: Create/Maintain Purchase Order, Send Purchase Order, Approve Purchase Order, Acknowledge Purchase Order, Monitor Purchase Order). The user can choose between the functions “De-activate” 522 (for a single business process element) and “Enhance” 524 (for a standard business process by business process elements of other standard business processes).

To shorten a standard business process (either at beginning, middle or end), the user can mark one of the process elements and press the button “De-activate” (e.g. Processing Purchase Orders: Acknowledge Purchase Order). As a consequence, the chosen business process element is de-activated so the business process runs without this process element. After de-activation, the process element in question is displayed differently in the business process Chevron graph (e.g. in different colors, grayed out). Also the related business entities (e.g. Processing Purchase Orders: Interactive Purchase Order form) are de-activated via corresponding business process switches. In order to guarantee that the business process is still running without gaps, the standard business process has to be enhanced by further elements like additional process agents in case the de-activated process element bridged deployment unit (DU) boundaries, and the related business entities have to be switched accordingly via the mechanism described before. This can also include the replacements of user interfaces (UIs) in case the original entry point has been skipped by the de-activation.

To add further business process elements to a standard business process, the user presses the “Enhance” 524 button. As a consequence, the business process is copied to the business process composition area 530. Next, the user chooses a standard business process, which will be displayed in the upper part 520 of the business process editor 540 and thus will replace the previously selected business process. Finally, in order to add process elements to the business process in the composition area 530, the user drags the process element to be added from the upper business process in the adaptation area 520 and drops it between two active process elements in the composition area 530, where the additional process elements has to be added. Alternatively, the “Add” 526 functionality could be used for the same purpose (e.g. Processing Purchase Orders: Create Advanced Shipping Notification coming from another standard process). Additional process elements (as process agents) are added automatically. Also, related business entities are switched accordingly (e.g. Processing Purchase Orders: Advanced Shipping Notification form added).

Replacement of business process elements by other standard business process elements can be realized by combining both actions “De-activate” 522 and “Enhance” 526. In both cases, the adapted standard business process has to be stored in a metadata repository for further editing and access during runtime. Therefore, the business process has to be given a name. Implicitly, also a unique identification is generated by the system in the background and the connection to the original standard business process is stored. After its activation the business process adaptation will be effective in the system. During runtime, the system overlays the standard business processes by adaptations related to them.

In the same tool, a new business process could be composed if appropriate (e.g. Processing Purchase Orders: Create/Maintain Purchase Order, Send Purchase Order, Approve Purchase Order, Monitor Purchase Order=>standard process shortened and changed). In order to do so, the user presses the “New” 532 button in the composition area 530 of the business process editor 540. As a consequence, an empty business process skeleton will be displayed in the composition area 530 to be filled in the next steps. Business process elements composing the new business process are picked up from one or more standard business processes. Therefore, the user selects a standard business process in the business process selection area 510 of the tool. Automatically the business process in its elements will be shown in the adaptation area 520 of the business process editor 540. Then, process elements are added by dragging process elements in the upper adaptation area 520 and dropping them at the desired position in the process composition area 530, thus composing the new business process. Alternatively, the “Add” 526 button could be used in the composition (e.g. Processing Purchase Orders: Approve Purchase Order with changed approval workflow criteria like site, product category, process type, etc.). If applicable, consistency checks are automatically performed by the system and facilitate the composition of a new partner business process. When saving and activating the new business process, the system sets switches and generates process agents and switches in order to guarantee process consistency during runtime.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

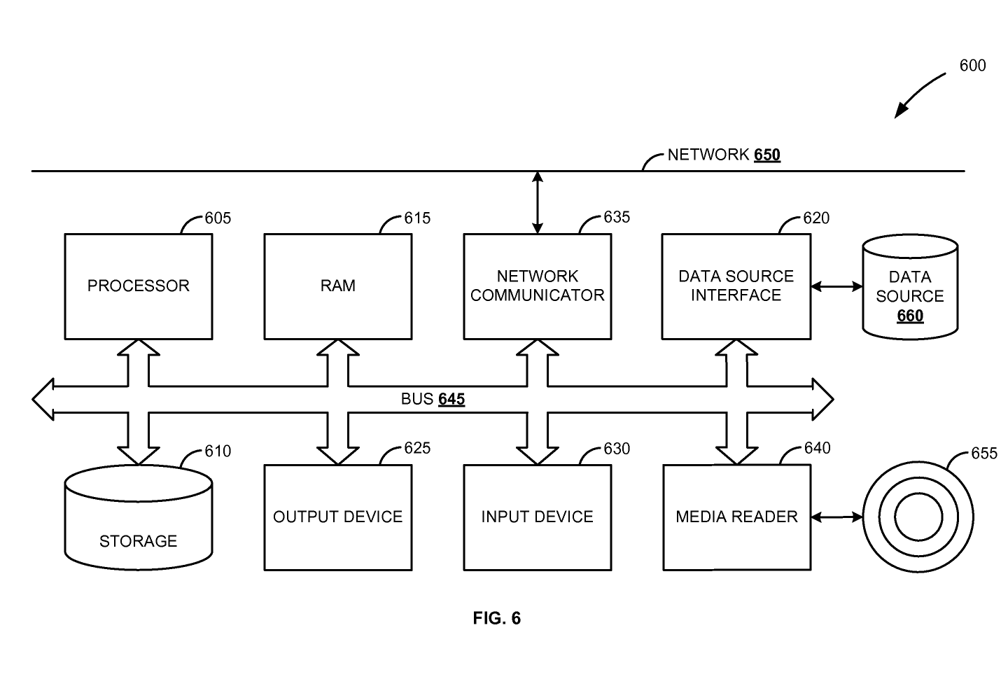

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for business process adaptation and composition, executing on a processor, the method comprising:
the processor identifying pre-delivered business process elements for business process composition;
the processor reusing the identified pre-delivered business process elements to compose a developed business process;
the processor switching business entities to the developed business process based on the reused identified pre-delivered business process elements; and
the processor persisting the developed business process in a repository.

2. The method of claim 1, wherein the business process elements are granular pieces for the business process composition.

3. The method of claim 1, wherein the business process elements are composed by two business object nodes, the two business object nodes representing data flow between the two business objects.

4. The method of claim 1, wherein reusing the identified pre-delivered business process elements to compose the developed business process further comprises adapting a predefined business process through the identified pre-delivered business process elements.

5. The method of claim 3, wherein adapting the predefined business process through the identified pre-delivered business process elements further comprises:
adding at least one of the identified pre-delivered business process elements to the predefined business process; and
removing at least one of the identified pre-delivered business process elements from the predefined business process.

6. The method of claim 1, further comprising determining relationship between the reused identified pre-delivered business process elements and the business entities.

7. The method of claim 1, wherein the business entities are one or more selected from the group consisting of user interfaces, forms, reports, and tasks.

8. A computer system for business process adaptation and composition comprising:
a processor; and
a memory in communication with the processor, the memory storing instructions related to:
an identifier module to identify pre-delivered business process elements for business process composition;
a composer module to reuse the identified pre-delivered business process elements to compose a developed business process;
a connector module to switch business entities to the developed business process based on the reused identified pre-delivered business process elements; and
a repository module to persist the developed business process.

9. The system of claim 8 wherein the business process elements are granular pieces for the business process composition.

10. The system of claim 8, wherein the business process elements are composed by two business object nodes, the two business object nodes representing data flow between the two business objects.

11. The system of claim 8, wherein the composer module is further operable to adapt a predefined business process through the identified pre-delivered business process elements.

12. The system of claim 11, wherein the composer module is further operable to:
add at least one of the identified pre-delivered business process elements to the predefined business process; and
remove at least one of the identified pre-delivered business process elements from the predefined business process.

13. The system of claim 8, wherein the connector module is further operable to determine relationship between the reused identified pre-delivered business process elements and the business entities.

14. An article of manufacture including a non-transitory computer readable storage medium to tangibly store instructions, which when executed by a computer, cause the computer to:
identify pre-delivered business process elements for business process composition;
reuse the identified pre-delivered business process elements to compose a developed business process;
switch business entities to the developed business process based on the reused identified pre-delivered business process elements; and
persisting the developed business process in a repository.

15. The article of manufacture of claim 14, wherein business process elements are granular pieces for the business process composition.

16. The article of manufacture of claim 15, wherein the business process elements are composed by two business object nodes, the two business object nodes representing data flow between the two business objects.

17. The article of manufacture of claim 14, wherein the instructions to reuse the identified pre-delivered business process elements to compose a developed business process further comprise instructions, which when executed by a computer, cause the computer to adapt a predefined business process through the identified pre-delivered business process elements.

18. The article of manufacture of claim 17, wherein the instructions to adapt a predefined business process through the identified pre-delivered business process elements further comprise instructions, which when executed by a computer, cause the computer to:
add at least one of the identified pre-delivered business process elements to the predefined business process; and
remove at least one of the identified pre-delivered business process elements from the predefined business process.

19. The article of manufacture of claim 14, further comprising instructions, which when executed by a computer, cause the computer to determine relationship between the reused identified pre-delivered business process elements and the business entities.

20. The article of manufacture of claim 14, wherein the business entities are one or more selected from the group consisting of user interfaces, forms, reports, and tasks.
